(19) United States
(12) Patent Application Publication
(10) Pub. No.: US 2021/0257957 A1
(43) Pub. Date: Aug. 19, 2021

(54) HYBRID ACTIVE HARMONIC FILTER FOR HIGH CURRENT DRIVES

(71) Applicant: Carrier Corporation, Palm Beach Gardens, FL (US)

(72) Inventors: Da Zhang, Middlebury, CT (US); Bassel Al-Annouf, Farmington, CT (US)

(21) Appl. No.: 16/973,106

(22) PCT Filed: Jul. 24, 2019
(86) PCT No.: PCT/US2019/043179

§ 371 Date: Dec. 8, 2020

Related U.S. Application Data
(60) Provisional application No. 62/703,627, filed on Jul. 26, 2018.

(51) Int. Cl. H02P 29/50; H02M 1/12; H02J 3/18

(52) U.S. Cl. CPC H02P 29/50; H02P 23/04; H02J 3/185; H02M 1/12

(57) ABSTRACT

A three-phase motor drive system for operation from a three-phase alternating current (AC) power source. The three-phase motor drive system includes a three-phase hybrid active harmonic filter (AHF) having an input operably connected to the three-phase AC power source, the three-phase hybrid active harmonic filter comprising an active harmonic filter operably connected in parallel with the three-phase AC power source and a three-phase AC reactor disposed in series between the input and an output of the hybrid active harmonic filter. The three-phase motor drive system also includes a three-phase variable frequency motor drive configured to provide excitation signals to a three-phase motor; and a three-phase AC motor operably connected to the three-phase variable frequency motor drive, the three-phase AC motor responsive the excitation signals.

### TECHNICAL FIELD

The subject matter disclosed herein relates generally to power and building systems, and more particularly to a hybrid power conditioner for a motor drive system having three phase drives electrically operating from a three phase alternating current (AC) source.

### BACKGROUND

Electric motors are well known and widely used. They come in a variety of sizes and styles. One example use of an electric motor is in an elevator machine that moves a drive sheave for propelling an elevator cab up or down through a hoistway, for example. Another use for an electric motor in a heating ventilation, air conditioning or refrigeration systems (HVACR).

When a sinusoidal voltage is applied to a non-linear load, such as a rectifier or passive front end converter of the VFD, the current drawn by the load is non-sinusoidal. Instead, the current waveform is complex and consists of a series of multiple sinusoidal signals that start at the fundamental frequency of the power system and occur at integer multiples of the fundamental frequency known as harmonics. Harmonic frequencies in a power system are a frequent cause of power quality problems. In addition, power systems designed to function at the fundamental frequency of the system may experience unsatisfactory operation and/or failure when subjected to voltages and currents that contain substantial harmonic elements.

A variable frequency drive is a solid state electronic power converting device used for controlling the rotational speed of an alternating current (AC) electrical motor by controlling the frequency of the electrical power supplied to the motor (as is known, the synchronous speed of an AC motor is determined by the frequency of the AC supply and the number of poles in the stator winding). Typically, a variable frequency drive first converts an AC input power to a DC intermediate power using a rectifier circuit. The DC intermediate power is then converted to a quasi-sinusoidal AC power using an inverter switching circuit. As noted above, variable frequency drives usually include rectifiers or passive front end converters in their front ends. As also noted above, rectifiers, being non-linear, produce harmonics and, sometimes, reactive power. It is always desirable to have filters between the voltage sources and the rectifiers so that the sources are protected from damage by the harmonics and/or reactive power. Traditionally, passive filters have been used for this purpose where they have been tuned to certain harmonic frequencies so that they behave as harmonic sinks. At the same time, the passive filters provide reactive power naturally, although the amount of the reactive power they provide is typically not enough to provide effective compensation for the reactive power described above. While a passive filter performs well in filtering a particular order of harmonics, it tends to couple with the power line impedance to form an oscillation circuit and thus introduces oscillating current.

Recently, active filters have also been used for this purpose. Active Harmonic Filters (AHF) use power electronic devices, such as electronic switches like Insulated Gate Bipolar Transistors (IGBTs), and switch them on and off intelligently so that they compensate for the harmonic current(s) and reactive power. In one configuration, the AHF injects current that is 180 degrees out of phase from the load harmonic current to compensate for that harmonic current. A hybrid filter is one that combines active harmonic filter schemes to compensate for harmonics generated by a non-linear load, while they also employ passive filters to filter high-order harmonics. Typically hybrid filter scheme have been included as part of the VFD or separately provided with parallel passive components. While the approaches described above have been effective in some applications, there is room for improvement in the area of harmonic filtering, reactive power compensation and/or oscillation dampening for power systems, particularly in high power applications where the electric current requirement for the power electronic devices used therein is one of the driving factors.

### BRIEF SUMMARY

According to an embodiment, described herein is a three-phase motor drive system for operation from a three phase alternating current (AC) power source. The three-phase motor drive system includes a three-phase hybrid active harmonic filter (AHF) having an input operably connected to the three phase AC power source, the three-phase hybrid active harmonic filter comprising an active harmonic filter operably connected in parallel with the three phase AC power source and a three phase AC reactor disposed in series between the input and an output of the hybrid active harmonic filter. The three-phase motor drive system also includes a three-phase variable frequency motor drive configured to provide excitation signals to a three phase motor; and a three-phase AC motor operably connected to the three-phase variable frequency motor drive, the three-phase AC motor responsive the excitation signals.

In addition to one or more of the features described above or below, or as an alternative, further embodiments could include that the three-phase variable frequency motor drive and three-phase AC motor are existing components of a legacy motor drive system.

In addition to one or more of the features described above or below, or as an alternative, further embodiments could include that the hybrid three-phase active harmonic filter is configured to operate with harmonic current exceeding a nominal rating of the active harmonic filter alone.

In addition to one or more of the features described above or below, or as an alternative, further embodiments could include that the active harmonic filter exceeding its nominal rating includes operating the three-phase variable frequency motor drive to produce a harmonic current in excess of a nominal rating of the active harmonic filter.

In addition to one or more of the features described above or below, or as an alternative, further embodiments could include that the AHF comprises a three phase legs, each operably coupled via an inductive element to a respective phase of the AC power source.

In addition to one or more of the features described above or below, or as an alternative, further embodiments could include that the AHF further includes a controller configured to generate control signals to the three-phase legs to control currents through the respective inductive elements to cause voltages to be induced on each phase of the three phase AC power source.

In addition to one or more of the features described above or below, or as an alternative, further embodiments could include a three phase AC reactor disposed in series between the input and an output of the hybrid active harmonic filter.

Also described herein, in another embodiment is a three-phase hybrid active harmonic filter (HAHF) having a three phase AC power input and a three-phase AC power output, the three-phase hybrid active harmonic filter comprising an active harmonic filter (AHF) operably connected in parallel with the three phase AC power input and a three phase AC reactor disposed in series between the three-phase AC input and the three-phase AC output.

In addition to one or more of the features described above or below, or as an alternative, further embodiments could include the hybrid three-phase active harmonic filter is configured to operate with harmonic current exceeding a nominal rating of the active harmonic filter alone.

In addition to one or more of the features described above or below, or as an alternative, further embodiments could include that the AHF comprises a three phase legs, each operably coupled via an inductive element to a respective phase of the AC power input.

In addition to one or more of the features described above or below, or as an alternative, further embodiments could include that the AHF further includes a controller configured to generate control signals to the three-phase legs to control currents through the respective inductive elements to cause voltages to be induced on each phase of the three phase AC power source.

In addition to one or more of the features described above or below, or as an alternative, further embodiments could include a three-phase variable frequency motor drive configured to provide excitation signals to a three phase motor; and a three-phase AC motor operably connected to the three-phase variable frequency motor drive, the three-phase AC motor responsive the excitation signals.

In addition to one or more of the features described above or below, or as an alternative, further embodiments could include that the three-phase variable frequency motor drive and three-phase AC motor are existing components of a legacy motor drive system.

In addition to one or more of the features described above or below, or as an alternative, further embodiments could include that the three-phase hybrid active harmonic filter is configured to operate with harmonic current exceeding a nominal rating of the active harmonic filter alone, wherein the active harmonic filter exceeding its nominal rating includes operating the three-phase variable frequency motor drive to produce a harmonic current in excess of a nominal rating of the active harmonic filter.

Also described herein in another embodiment is a method of operating a three phase motor drive system having a three-phase AC motor drive operably connected to a three-phase motor from a three phase AC power source. The method includes operably connecting a three-phase hybrid active harmonic filter (AHF) having an input operably connected to the three phase AC power source, the three-phase hybrid active harmonic filter comprising an active harmonic filter operably connected in parallel with the three phase AC power source and a three phase AC reactor disposed in series between the input and an output of the hybrid active harmonic filter, operably connecting the three-phase variable frequency motor drive to the three-phase hybrid AHF, the three-phase variable frequency motor drive configured to provide excitation signals to the three phase motor, and operating the three-phase motor drive based on the excitation signals.

In addition to one or more of the features described above or below, or as an alternative, further embodiments could include that the three-phase variable frequency motor drive and three-phase AC motor are existing components of a legacy motor drive system.

In addition to one or more of the features described above or below, or as an alternative, further embodiments could include that the AHF comprises a three phase legs, each operably coupled via an inductive element to a respective phase of the AC power source.

In addition to one or more of the features described above or below, or as an alternative, further embodiments could include that the AHF further includes a controller configured to generate control signals to the three-phase legs to control currents through the respective inductive elements to cause voltages to be induced on each phase of the three phase AC power source.

In addition to one or more of the features described above or below, or as an alternative, further embodiments could include a three phase AC reactor disposed in series between the input and an output of the hybrid active harmonic filter.

In addition to one or more of the features described above or below, or as an alternative, further embodiments could include that the drive and the motor is connected to at least one of an elevator system, a heating ventilation, and air conditioning system, and a refrigeration system.

Other aspects, features, and techniques of embodiments will become more apparent from the following description taken in conjunction with the drawings.

### BRIEF DESCRIPTION OF THE DRAWINGS

The described subject matter is particularly pointed out and distinctly claimed in the claims at the conclusion of the specification. The foregoing and other features, and advantages are apparent from the following detailed description taken in conjunction with the accompanying drawings in which:

FIG. 1 is a block diagram of components of a motor drive system;

FIG. 2 is a block diagram of a three-phase motor drive system in an single phase application in accordance with an embodiment;

FIG. 3 is a partial simplified schematic of a three-phase motor drive system and hybrid active harmonic filter in accordance with an embodiment; and

FIG. 4 depicts a flowchart of a method of operating a three-phase motor drive system in accordance with an embodiment.

### DETAILED DESCRIPTION

In general, embodiments herein relate to a hybrid AHF that combines active harmonics regulation elements with a passive element that consists of three phase AC reactor in the same packaging. The hybrid AHF is configured to be introduced between an AC power source and a VFD and to reduce the THD and limit the harmonic currents on the VFD input. Advantageously, the AHF need provide significantly lower currents to compensate the harmonic currents and meet the THD requirements on grid. Moreover, the hybrid AHF provides significant cost benefits and application flexibility for high tier VFD product applications and facilitates application to many commercial VFDs applications. One significant advantage is that the cost of “extra” AC reactor to reduce harmonic currents as employed in the hybrid AHF is generally much lower when compared to the cost of a larger/higher current rated AHF unit or VFD.

Embodiments herein are directed to a system controller providing three phase AC power to a VFD in a motor drive application. Embodiments herein set forth a hybrid AHF, operably connected in series in advance of the VFD, and motor system operating from a three phase AC power source.

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended. The following description is merely illustrative in nature and is not intended to limit the present disclosure, its application or uses. It should be understood that throughout the drawings, corresponding reference numerals indicate like or corresponding parts and features. As used herein, the term controller refers to processing circuitry that may include an application specific integrated circuit (ASIC), an electronic circuit, an electronic processor (shared, dedicated, or group) and memory that executes one or more software or firmware programs, a combinational logic circuit, and/or other suitable interfaces and components that provide the described functionality.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in Figure X may be labeled “Xa” and a similar feature in Figure Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

In an embodiment, a three-phase VFD operating from a hybrid AHF and a three phase AC source is utilized in an electric motor system or power system. In one application, the power system is part of an elevator system. The elevator system also includes a hoistway having one or more of lanes or shafts. In each shaft, one or more elevator car travels to deliver passengers to a desired floor of a building. The electric motor system utilizes the power electronics inverter (e.g., as variable speed alternating drive (AC) motor drive) to improve the performance of maneuvering the elevator cars. Other applications and embodiments include power systems for trains, boats, planes, etc. Further, in another embodiment a three phase drive is used to drive a motor in a heating ventilation and air conditioning or refrigeration system HVAC/R system. The conventional HVAC/R system incorporates a closed refrigerant loop in a vapor compression cycle. The vapor-compression cycle uses a circulating refrigerant as the medium which absorbs and removes heat from the space to be cooled and subsequently rejects that heat elsewhere. All such systems have four basic components: a compressor, a condenser, a thermal expansion valve (also called a throttle valve or metering device), and an evaporator. In large scale HVAC systems or chillers, the compressor is large and driven by a very large motor requiring dedicated motor drives such as described herein with high voltage and current capabilities. In some instances the drive may include a converter that is a three-phase active front-end. The drive may also include a power electronics inverter (e.g., as a variable speed alternating current (AC) motor drive) to improve the performance of the chiller system. In an embodiment a three phase active converter operating from a single phase excitation and three phase inverter is used to drive a motor is disclosed.

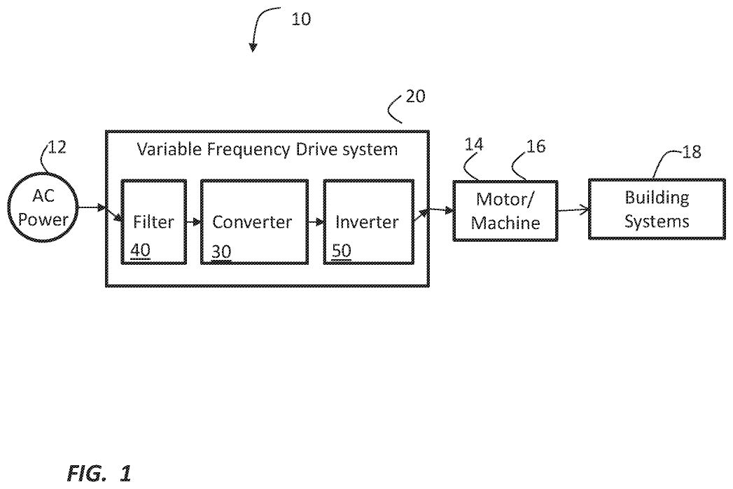

FIG. 1 is a block diagram of components of a typical power system 10 as may be employed to power one or more building systems or loads 18. The power system 10 is described with respect to elevator system, however application to any system where a motor drive is employed may be envisioned. Power system 10 includes a source of AC power 12, such as an electrical main line (e.g., 440/220 volt, 3-phase). The AC power 12 is provided to a drive system 20. In addition, the drive system 20 may be configured as a conventional three phase drive operating from a three phase AC power 12. The drive 20 may include a filter 40 configured to limit inrush currents, stabilizes voltage levels and suppress electromagnetic interference (EMI). The drive may also include a converter 30 to convert the AC power 12 to a DC voltage. Each drive also includes an inverter 50 to convert the DC voltage to multiphase, AC drive signals. Drive signals from the inverter 50 of the drive system 20 are supplied to a multiphase machine 14 to control a building system. For example, a motor 16 to impart motion to elevator car as part of the building system 18. In an exemplary embodiment, machine 14 includes a multiphase, permanent magnet synchronous motor 16.

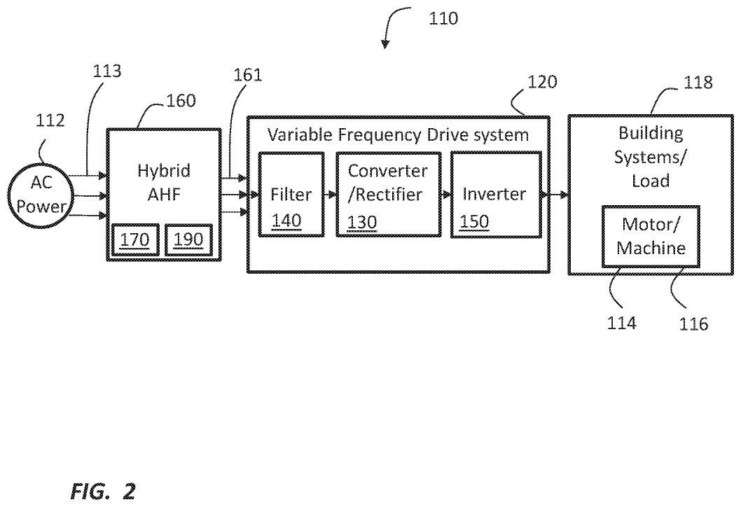

FIG. 2 is a block diagram of components of a power system 110 as may be employed in accordance with one or more embodiments to power one or more building systems or loads 118. Once again, the power system 110 is described with respect to elevator system and/or HVAC/R system, however application to any system where a motor drive is employed may be envisioned. Power system 110 includes a source 112 of AC power 113, such as an electrical main line (e.g., 440/220 volt, 3-phase). The AC power 113 is provided by the AC power source 112 to hybrid Active Harmonic Filter (AHF) 160. The hybrid AHF 160 includes an AHF 170 operably connected in parallel with the AC power 113 and configured to compensate for harmonic distortion caused by a downstream loads form being transmitted back to the AC power 113 and ultimately the AC power source 112. The hybrid AHF 160 also includes a passive three phase filter 190 operably connected in series between the AC power 112 and the output of the hybrid AHF 160, the passive three phase filter 190 is configured to reduce harmonic currents, limit current transients, stabilize voltage levels and suppress electromagnetic interference (EMI) from being reflected/transmitted back to the AC power source 112. The output of the hybrid AHF 160 is a compensated three phase AC power 161, which is then connected to the drive system 120 (e.g., a VFD).

Power system 110 also include a drive system 120, which may be configured as a conventional three phase drive operating from a three phase power as supplied and compensated by the hybrid AHF 160. As described above, the drive 120 may include a filter 140 configured to limit inrush currents, stabilizes voltage levels and suppress electromagnetic interference (EMI). The drive system 120 may also include a converter 130 to convert the (compensated) AC power 161 (as supplied from the hybrid AHF 160) to a DC voltage. Each drive 120 also includes an inverter 150 to convert the DC voltage to multiphase, AC drive signals. Drive signals from the inverter 150 of the drive system 120 are supplied to a multiphase machine 114 to control a building system 118. For example, a motor 116 to drive a chiller compressor as part of the building system 118. In an exemplary embodiment, machine 114 includes a multiphase, permanent magnet synchronous motor 116. It should be appreciated, that while the embodiments herein are described primarily with reference to an elevator system or HVAC/R system and their applications, this description is for example only. The embodiments described here are readily applied to any application employing a three phase drive and three phase motor 116 including HVAC, refrigeration and any other power system and motor control application.

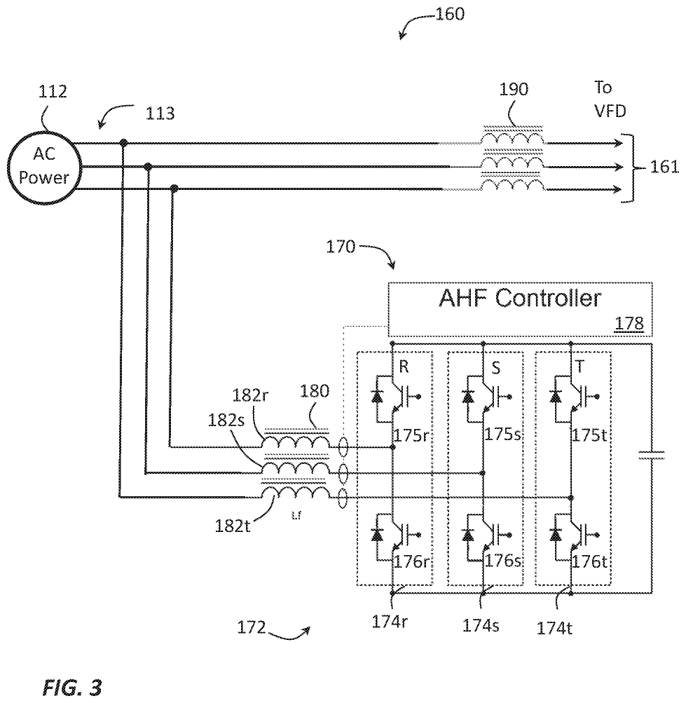

FIG. 3 is an expanded view of the hybrid AHF 160 in accordance with an embodiment. The hybrid AHF 160 includes an AHF 170 operably connected in parallel with the AC power 113 and configured to compensate for harmonic distortion caused by a downstream loads form being transmitted back to the AC power 113 and ultimately the AC power source 112. The AHF 170 includes a three phase boost converter 172 configured with three phase legs 174, R, S, and T also denoted as 174r, 174s, and 174t respectively. Each phase leg, R, S, and T, (174r, 174s, and 174t) includes switching devices 175, 176 operating in complementary pairs controlled by control signals (not shown) from an AHF controller 178 to formulate compensation voltages to be added/introduced to the AC power 113. The three phase AC power 113 from the AC power source 112 is connected to the converter 172 via a three phase inductor 180. The three phase inductor 180 includes three inductive/reactive elements denoted 182r, 182s, and 182t (e.g., inductors) and then connected to the three phase legs R, S, and T, (174r, 174s, and 174t) respectively. In an embodiment, drive controller 178 may be implemented using a general-purpose microprocessor executing a computer program stored on a storage medium to perform the operations described herein. Alternatively, drive controller 178 may be implemented in hardware (e.g., ASIC, FPGA) or in a combination of hardware/software as described herein.

The hybrid AHF 160 also includes a passive three phase filter 190 operably connected in series between the AC power 112 and the output of the hybrid AHF 160, the passive three phase filter 190 is configured to reduce harmonic currents, limit current transients, stabilize voltage levels and suppress electromagnetic interference (EMI) from being reflected/transmitted back to the AC power source 112. The output of the hybrid AHF 160 is a compensated three phase AC power 161, which is then connected to the drive system 120 (e.g., a VFD).

Conventionally, in application of the AHF e.g., 170, the AC power 113 (or 161) is monitored by the controller 178. Control signals are generated by the controller 178 to cause the switching device pairs 175r, 176r, 175s, 176s, and 175t, 176t for each of the respective phase legs 174r, 174s, and 174t of the converter 172 to control the current flowing through the inductances 182r, 182s, and 182t respectively. Thereby, based on voltages introduced on the AC power, e.g., 113, 161, voltages can be induced on each of the respective phase of the AC power 113. The voltages induced are configured to compensate for the harmonics generated by the VFD 120 and the load, e.g., motor 116.

It will be appreciated that in an embodiment that by employing the hybrid AHF 160 as described with both a parallel configured AHF 170 and integral series connected in passive three phase filter or reactor 190 facilitates improvement in motor drive 120 (e.g., VFD) function, performance, and cost effectiveness. In particular, the described embodiments of the hybrid AHF 160 permit operation of existing motor drives 120 (e.g., VFD's) in applications beyond their nominal current ratings for power, in-rush current, and harmonic distortion. Therefore for selected applications use of a hybrid AHF 160 and a conventional motor drive 120 facilitates satisfying system requirements without having to select and resort to higher nominal current rated motor drives. As will be appreciated as the current rating of a motor drive is increased, the cost, size and complexity significantly increase. The described embodiments provide system designers an opportunity to implement lower cost systems that exhibit improved performance and yet reduced cost. Moreover, the described embodiments facilitate applications in retrofit applications that may permit existing motor drives 120 (e.g., an existing VFD) to be operated in applications beyond prior or existing requirements, particularly harmonic current requirements.

Advantageously, each of the configurations described with respect to the various embodiments results in improved capability of the system to handle additional current, harmonics and EMI suppression relative to the conventional configuration of FIG. 1. As such, when a conventional three phase motor drive e.g., motor drive 20 is employed with the hybrid AHF 160 of the described embodiments increased harmonic current performance can be achieved. Moreover, advantageously though, the cost savings or avoidance when compared to implementations employing higher rated drives can be significant as procurement of higher current higher tier drive may be excessive for the application when compared to the cost of the hybrid AHF 160.

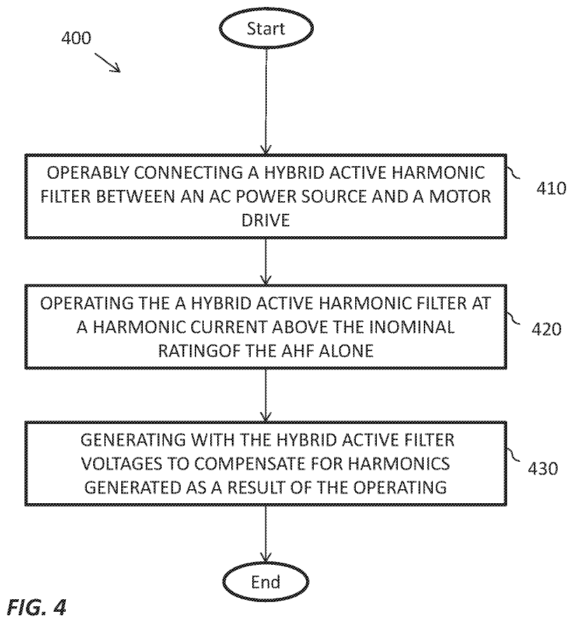

Turning now to FIG. 4, where a methodology 400 for employing a hybrid AHF 160 with in accordance with an embodiment. For simplicity, reference is made to drive 120 and hybrid AHF 160 of FIGS. 2 and 3 and their various elements, while it should be appreciated the description may be equally applicable to the other embodiments and so on. Continuing with FIG. 4, the method initiates at process step 410 with operably connecting the three phase hybrid AHF 160 between an AC power source 112 and a three phase motor drive 120. As depicted at process step 420, the method 400 continues with operating the hybrid AHF in a manner that is beyond the nominal ratings of the AHF alone. For example such operation can include, but not be limited to operating at a harmonic current higher than its rating, generating higher than rated harmonic current loading on the AC power supply e.g., 112, or in the embodiments, 161, and generating higher than rated EMI. Finally at process step 430, the method 400 continues with generating with the hybrid AHF 160 voltages to compensate for the harmonics and EMI generated by the motor drive 120.

Embodiments include the use of a hybrid AHF 160 with three phase motor drives 120 in order to meet applications where a higher rated drive would otherwise be required. This eliminates the cost and/or development time associated with a higher capability, more expensive drives and expands the range of potential applications based on selective combinations of components. Advantageously, the embodiments described herein facilitate taking complete advantage of the legacy three phase drives to save costs and improve current capability and limit derating.

The terminology used herein is for the purpose of describing particular embodiments only and is not intended to be limiting. While the description has been presented for purposes of illustration and description, it is not intended to be exhaustive or limited to the form disclosed. Many modifications, variations, alterations, substitutions, or equivalent arrangement not hereto described will be apparent to those of ordinary skill in the art without departing from the scope of the disclosure. Additionally, while the various embodiments have been described, it is to be understood that aspects may include only some of the described embodiments. Accordingly, embodiments are not to be seen as being limited by the foregoing description, but is only limited by the scope of the appended claims.

What is claimed is:

1. A three-phase motor drive system for operation from a three phase alternating current (AC) power source:
a three-phase hybrid active harmonic filter (HAHF) having an input operably connected to the three phase AC power source, the three-phase hybrid active harmonic filter comprising an active harmonic filter (AHF) operably connected in parallel with the three phase AC power source and a three phase AC reactor disposed in series between the input and an output of the hybrid active harmonic filter;
a three-phase variable frequency motor drive configured to provide excitation signals to a three phase motor; and
a three-phase AC motor operably connected to the three-phase variable frequency motor drive, the three-phase AC motor responsive the excitation signals.

2. The three-phase motor drive system of claim 1, wherein the three-phase variable frequency motor drive and three-phase AC motor are existing components of a legacy motor drive system.

3. The three-phase motor drive system of claim 2, wherein the hybrid three-phase active harmonic filter is configured to operate with harmonic current exceeding a nominal rating of the active harmonic filter alone.

4. The three-phase motor drive system of claim 3, wherein the active harmonic filter exceeding its nominal rating includes operating the three-phase variable frequency motor drive to produce a harmonic current in excess of a nominal rating of the active harmonic filter.

5. The three-phase motor drive system of claim 1, wherein the AHF comprises a three phase legs, each operably coupled via an inductive element to a respective phase of the AC power source.

6. The three-phase motor drive system of claim 1, wherein the AHF further includes a controller configured to generate control signals to the three-phase legs to control currents through the respective inductive elements to cause voltages to be induced on each phase of the three phase AC power source.

7. A three-phase hybrid active harmonic filter (HAHF) having a three phase AC power input and a three-phase AC power output, the three-phase hybrid active harmonic filter comprising an active harmonic filter (AHF) operably connected in parallel with the three phase AC power input and a three phase AC reactor disposed in series between the three-phase AC input and the three-phase AC output.

8. The three-phase hybrid active harmonic filter of claim 7, wherein the hybrid three-phase active harmonic filter is configured to operate with harmonic current exceeding a nominal rating of the active harmonic filter alone.

9. The three-phase hybrid active harmonic filter of claim 7, wherein the AHF comprises a three phase legs, each operably coupled via an inductive element to a respective phase of the AC power input.

10. The three-phase hybrid active harmonic filter of claim 1, wherein the AHF further includes a controller configured to generate control signals to the three-phase legs to control currents through the respective inductive elements to cause voltages to be induced on each phase of the three phase AC power source.

11. The three-phase hybrid active harmonic filter of claim 7, further including:
a three-phase variable frequency motor drive configured to provide excitation signals to a three phase motor; and
a three-phase AC motor operably connected to the three-phase variable frequency motor drive, the three-phase AC motor responsive the excitation signals.

12. The three-phase hybrid active harmonic filter of claim 7, wherein the three-phase variable frequency motor drive and three-phase AC motor are existing components of a legacy motor drive system.

13. The three-phase hybrid active harmonic filter of claim 12, wherein the three-phase hybrid active harmonic filter is configured to operate with harmonic current exceeding a nominal rating of the active harmonic filter alone, wherein the active harmonic filter exceeding its nominal rating includes operating the three-phase variable frequency motor drive to produce a harmonic current in excess of a nominal rating of the active harmonic filter.

14. A method of operating a three phase motor drive system having a three-phase AC motor drive operably connected to a three-phase motor from a three phase AC power source, the method comprising:
operably connecting a three-phase hybrid active harmonic filter (HAHF) having a three-phase input operably connected to the three phase AC power source, the three-phase hybrid active harmonic filter comprising an active harmonic filter operably connected in parallel with the three phase input and a three phase AC reactor disposed in series between the input and an output of the hybrid active harmonic filter;
operably connecting the three-phase variable frequency motor drive to the three-phase hybrid AHF, the three-phase variable frequency motor drive configured to provide excitation signals to the three phase motor; and
operating the three-phase motor based on the excitation signals.

15. The method of operating a three phase motor drive system of claim 14, wherein the three-phase variable frequency motor drive and three-phase AC motor are existing components of a legacy motor drive system.

16. The method of operating a three phase motor drive system of claim 15, wherein the hybrid three-phase active harmonic filter is configured to operate with harmonic current exceeding a nominal rating of the active harmonic filter alone.

17. The method of operating a three phase motor drive system of claim 15, wherein the active harmonic filter exceeding its nominal rating includes operating the three-phase variable frequency motor drive to produce a harmonic current in excess of a nominal rating of the active harmonic filter.

18. The method of operating a three phase motor drive system of claim 14, wherein the AHF comprises a three phase legs, each operably coupled via an inductive element to a respective phase of the AC power source.

19. The method of operating a three phase motor drive system of claim 14, wherein the AHF comprises a three phase legs, each operably coupled via an inductive element to a respective phase of the AC power source.

20. The method of operating a three phase motor drive system of claim 19, wherein the AHF further includes a controller configured to generate control signals to the three-phase legs to control currents through the respective inductive elements to cause voltages to be induced on each phase of the three phase AC power source.
